(19) United States
(12) Patent Application Publication
(10) Pub. No.: US 2010/0108253 A1
(43) Pub. Date: May 6, 2010

(54) Sealing material to metal bonding compositions and methods for bonding a sealing material to a metal surface

(76) Inventors: James C. Doane, Friendswood, TX (US); Darrin L. Willauer, The Woodlands, TX (US); James E. Goodson, Porter, TX (US)

Correspondence Address: GREENBERG TRAURIG (HOU);INTELLECTUAL PROPERTY DEPARTMENT, 1000 Louisiana Street, Suite 1800, Houston, TX, 77002, US

(21) Appl. No.: 12/655,272

(22) Filed: Dec. 28, 2009

Related U.S. Application Data
(62) Division of application No. 11/724,367, filed on Mar. 15, 2007.

(51) Int. Cl. B29C 65/54

(52) U.S. Cl. 156/275.7

(57) ABSTRACT

A downhole well tool having a component with a metal surface to which a sealing material is adhered is disclosed. The sealing material is bonded to the metal surface through the use of an energetic material disposed between the sealing material and the metal surface. Upon activation or initiation of the energetic material, the sealing material becomes bonded to the metal surface. A plastic layer may be disposed between the sealing material and the metal surface to facilitate bonding sealing material to the metal surface. The energetic material is used to bond the plastic layer to the metal surface and may be used to bond the plastic layer to the sealing material.

### BACKGROUND

1. Field of Invention

The invention is directed to materials and methods for bonding a sealing material to a metal surface of downhole tools, such as a packer having a sealing element and, in particular, materials and methods for bonding a sealing material to a metal surface of downhole tools that remain effective at temperatures greater than 400° F.

2. Description of Art

Sealing materials are routinely bonded or adhered to a metal surface of downhole tools. To adhere or bond the sealing material to the steel housing of a downhole tool, for example, the prior art tools used chemical bonding or adhesion components to secure the sealing material to the steel housing. These chemical compounds, however, become less effective as the temperature increases, especially where the temperature increases above 400° F., such as those temperatures found in deep oil and gas well. Current technology limits the ability to bond a sealing material such as rubber to steel at such high temperatures. For example, even though there are high temperature chemical adhesion compounds, these compounds do not work effectively for sealing material-to-metal contact. As a result, the adhesion of the sealing material to the outer surface of the downhole tool is compromised and the sealing material is released from the outer surface of the downhole tool. Accordingly, the tool becomes inoperable or ineffective.

Additionally, fluids within the well that flow around and past the downhole tools, either flowing up the well or down the well, slowly undermine the chemical compound securing the sealing material to the outer surface of the downhole tools. The flowing fluids may dissolve or otherwise prevent the chemical compound from maintaining its bonding capabilities. Further, the flowing fluids may force themselves, together with debris carried in the flowing fluids, between the interface of the sealing material with the metal surface of the downhole tool. Therefore, the flowing fluid, either alone or in combination with elevated temperatures within the well, can cause the bond of the sealing material to the metal surface to weaken, thereby causing the seal to leak and, thus, rendering the tool inoperable or ineffective. As a result, costs are increased for replacing and repairing, if possible, the damaged downhole tool having an insufficiently secured sealing material to metal wall surface of the downhole tool.

Accordingly, prior to the development of the materials and downhole tools disclosed herein, there have been no downhole tools having a sealing material secured to the metal outer wall surface of a downhole tool that: increases the life of the downhole tool by increasing the length of time the sealing material remains bonded to a metal wall surface of the downhole tools and, thus, decreases the costs associated with replacing and repairing the downhole tools; and provides more effective bonding of the sealing material at elevated temperatures. Therefore, the art has sought downhole tools having a sealing material secured to a metal wall surface of a downhole tool that: increase the life of the downhole tool by increasing the length of time the sealing material remains bonded to the metal wall surface of the downhole tools and, thus, decrease the costs associated with replacing and repairing the downhole tools; and provide more effective bonding of the sealing material at elevated temperatures.

### SUMMARY OF INVENTION

Broadly, the downhole tools disclosed herein include a sealing material secured to a metal surface of the downhole tool through the use of an energetic material disposed between the sealing material and the metal surface and subsequently initiating the energetic material to bond the sealing material to the metal surface. In one embodiment, the sealing material is bonded directly to the metal surface. In another embodiment, the sealing material is first bonded to a plastic material, such as through the use of a high-temperature chemical bonding agent or the energetic material, and the plastic material is then bonded to the metal surface using the energetic material. In an additional specific embodiment, a plastic material is first bonded to the metal surface using the energetic material and the sealing material is then bonded to the plastic. In yet another specific embodiment, the sealing material is bonded to the plastic simultaneously with the plastic being bonded to the metal surface.

The foregoing downhole tools having a sealing material secured to a metal wall surface of a downhole tool have the advantages of: increasing the life of the downhole tool by increasing the length of time the sealing material remains bonded to the metal wall surface of the downhole tools and, thus, decreasing the costs associated with replacing and repairing the downhole tools; and providing more effective bonding of the sealing material at elevated temperatures.

In accordance with the disclosure herein, one or more of the foregoing advantages may also be achieved through the present component of a downhole tool. The component comprises a metal surface, a sealing material, and an energetic material, wherein the energetic material bonds the sealing material to the metal surface through activation, e.g., combustion or chemical reaction, of the energetic material.

A further feature of the downhole tool component is that the energetic material may comprise a thermite. Another feature of the downhole tool component is that the thermite may comprise sub-micron thermite particles. An additional feature of the downhole tool component is that the energetic material may comprise at least one reactant for forming an intermetallic compound. Still another feature of the downhole tool component is that at least one of the at least one reactants for forming the intermetallic compound may comprise sub-micron reactant compound particles. A further feature of the downhole tool component is that the sealing material may be selected from the group consisting of styrene-butadiene copolymer, neoprene, nitrile rubber, butyl rubber, polysulfide rubber, cis-1,4-polyisoprene, ethylene-propylene terpolymers, EPDM rubber, silicone rubber, polyurethane rubber, and thermoplastic polyolefin rubbers. Another feature of the downhole tool component is that the durometer hardness of the sealing material may be in the range from about 60 to 100 Shore A. An additional feature of the downhole tool component is that the metal surface may be disposed on an outer surface of a housing of the downhole tool. Still another feature of the downhole tool component is that the downhole tool may be a sealing device. A further feature of the downhole tool component is that the sealing device may be a packer. Another feature of the downhole tool component is that the sealing material may be bonded directly to the metal surface by the energetic material, and the energetic material may be capable of generating sufficient heat to cause the sealing material to at least partially melt and become bonded to the metal surface without an outer surface of the sealing material melting. An additional feature of the downhole tool component is that the downhole tool component may further comprise a plastic layer disposed between the sealing material and the metal surface, the plastic layer being bonded directly to the metal surface by the energetic material.

In accordance with the disclosure herein, one or more of the foregoing advantages may also be achieved through the present method of bonding a sealing material to a metal surface of a component of a downhole tool. The method comprises the steps of: (a) disposing an energetic material between a sealing material and a metal surface of a component of a downhole tool; and (b) energizing the energetic material to create sufficient heat to cause the sealing material to be bonded to the metal surface of the component of the downhole tool.

A further feature of the method of bonding a sealing material to a metal surface of a component of a downhole tool is that wherein the sealing material may be first bonded to a plastic layer and the energetic material is disposed between the plastic layer and the metal surface of the component of the downhole tool prior to step (b). Another feature of the method of bonding a sealing material to a metal surface of a component of a downhole tool is that the metal surface of the component of the downhole tool may be first bonded to a plastic layer by disposing the energetic material between the plastic layer and the metal surface of the component of the downhole tool; the energetic material may then be energized to bond the plastic layer to the metal surface of the component of the downhole tool; and the sealing material may then be bonded to the plastic layer. An additional feature of the method of bonding a sealing material to a metal surface of a component of a downhole tool is that the plastic layer may be a perfluoroalkoxy material. Still another feature of the method of bonding a sealing material to a metal surface of a component of a downhole tool is that the sealing material may be bonded to the plastic layer by disposing additional energetic material between the sealing material and the plastic layer and energizing the energetic material. A further feature of the method of bonding a sealing material to a metal surface of a component of a downhole tool is that the energetic material may comprise a thermite. Another feature of the method of bonding a sealing material to a metal surface of a component of a downhole tool is that the energetic material may comprise at least one reactant for forming an intermetallic compound. An additional feature of the method of bonding a sealing material to a metal surface of a component of a downhole tool is that a bonding metal may be disposed on a bonding surface of the sealing material prior to step (b).

### BRIEF DESCRIPTION OF DRAWINGS

FIG. 1 is a partial cross-sectional view of a packer showing a seal ring disposed on the outer surface of the downhole tool, the seal ring having a metal surface with a sealing material bonded thereto.

FIG. 2 is partial cross-sectional top view of one specific embodiment of a seal ring of the downhole tool of FIG. 1 showing an energetic material disposed between a sealing material and a metal surface of the seal ring prior to bonding the sealing material to the metal surface.

FIG. 3 is a partial cross-sectional top view of the seal ring shown in FIG. 2 after initiation of the energetic material and, thus, bonding of the sealing material to the metal surface.

FIG. 4 is partial cross-sectional top view of another specific embodiment of a seal ring of the downhole tool of FIG. 1 showing a sealing material bonded to a plastic layer and an energetic material disposed between the plastic layer and a metal surface of the seal ring prior to bonding the plastic layer to the metal surface.

FIG. 5 is a partial cross-sectional top view of the seal ring shown in FIG. 4 after initiation of the energetic material and, thus, bonding of the sealing material to the metal surface.

FIG. 6 is partial cross-sectional top view of an additional specific embodiment of a seal ring of the downhole tool of FIG. 1 showing a sealing material bonded to a plastic layer and an energetic material disposed between the plastic layer and a metal surface, as well as between the plastic layer and the sealing material, of the seal ring prior to bonding the plastic layer to the metal surface.

FIG. 7 is partial cross-sectional top view of an additional specific embodiment of a seal ring of the downhole tool of FIG. 1 showing a sealing material bonded to a metal layer and an energetic material disposed between the metal layer and a metal surface of the seal ring prior to bonding the sealing material to the metal surface.

While the invention will be described in connection with the preferred embodiments, it will be understood that it is not intended to limit the invention to that embodiment. On the contrary, it is intended to cover all alternatives, modifications, and equivalents, as may be included within the spirit and scope of the invention as defined by the appended claims.

### DETAILED DESCRIPTION OF INVENTION

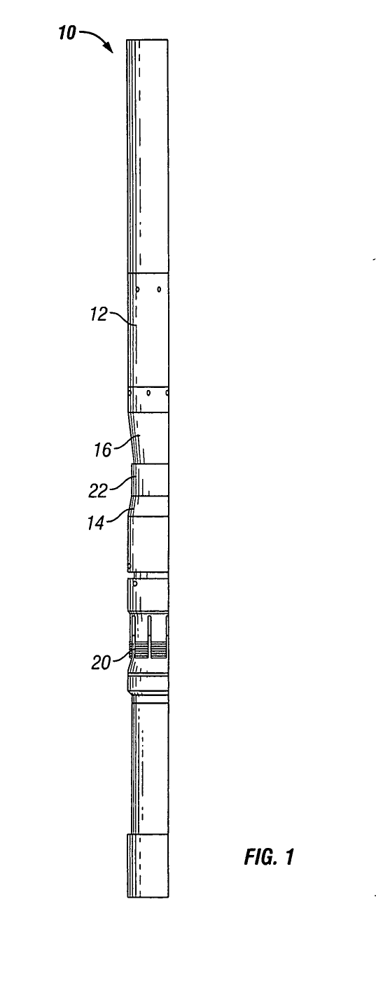

Referring now to FIG. 1, a downhole tool, such as a packer 10, includes a body or housing 12 and a sealing member or seal ring 22 disposed on the outer surface of housing 12 for sealing against a surrounding well casing. Housing 12 is generally cylindrical but may be any shape desired or necessary to form the downhole tool. An actuating member 14 is mounted to housing 12 for axial movement relative to housing 12. In this example, actuating member 14 engages a lower end of seal ring 22 for pushing seal ring 22 upward on a stationary cam surface 16 of housing 12 to cause seal ring 22 to expand radially into the set position. Cam surface 16 is preferably conical. Actuating member 14 may be an annular collet that is radially expansible, or it could be other configurations. In this embodiment, actuating member 14 is secured to a piston (not shown) supplied with hydraulic pressure for moving seal ring 22 relative to cam surface 16.

Tool 10 may be of a conventional design, and actuating member 14 may be moved by a variety of means other than hydraulic pressure, such as employing the weight of the running string (not shown) for tool 10, hydrostatic wellbore pressure, wireline movement, or explosives. Also, although seal ring 22 is shown moving upward onto stationary cam surface 16, the arrangement could be reversed, with seal ring 22 being moved downward. Further, seal ring 22 could be held axially stationary and cam surface 16 be moved relative to seal ring 22. For example, actuating member 14 may actually be held stationary while the running string and housing 12 move downward relative to seal ring 22, pushing seal ring 22 farther onto conical cam surface 16. Alternately, actuating member 14 may move upward relative to seal 22. Regardless of the arrangement, while being set, seal ring 22 and cam surface 16 move axially relative to each other to deform seal ring 22 radially outward to a larger diameter for engaging an inner wall surface of an outer tubular member (not shown) into which tool 10 is lowered. Outer tubular member may be a string of casing. As shown in FIG. 1, tool 10 in this example also has a set of slips 20 that expand outward and frictionally grip the inner wall surface of the outer tubular member.

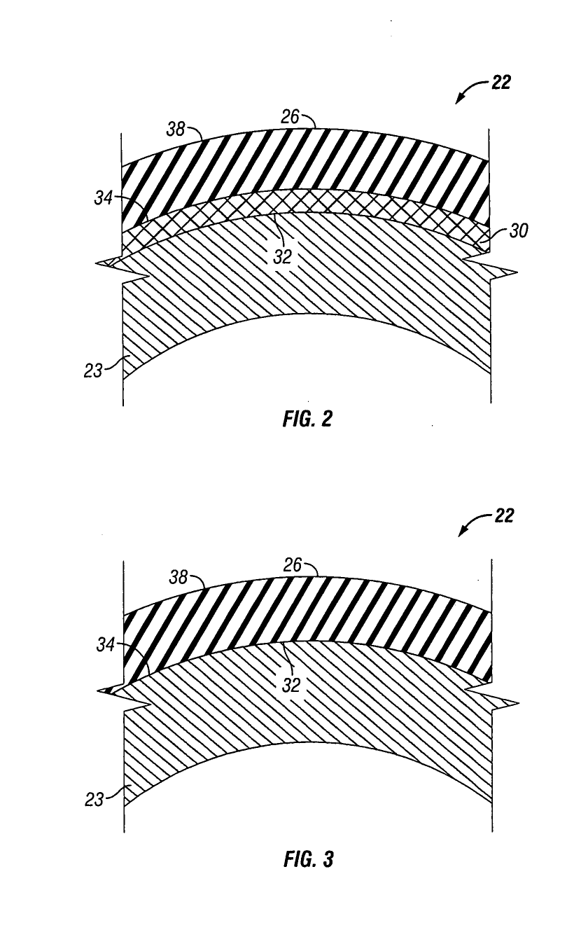

With reference to FIG. 2, seal ring 22 has an internal metal reinforcing element 23, thus providing a metal surface. Preferably reinforcing element 23 is formed of a carbon steel. A sealing material 26 is bonded to the metal surface of reinforcing element 23 through the use of an energetic material (discussed in greater detail below).

Sealing material 26 may be any material known to persons of ordinary skill in the art. In the preferred embodiment, sealing material 26 is a resilient, elastomeric or polymeric material of a commercially available type that will withstand high temperatures that occur in some wells. For example, sealing material 26 may be a perfluoro elastomer, a styrene-butadiene copolymer, neoprene, nitrile rubber, butyl rubber, polysulfide rubber, cis-1,4-polyisoprene, ethylene-propylene terpolymers, EPDM rubber, silicone rubber, polyurethane rubber, or thermoplastic polyolefin rubbers. Preferably, the durometer hardness of sealing material 26 is in the range from about 60 to 100 Shore A and more particularly from 85 to 95 Shore A. In one embodiment, the durometer hardness is about 90 Shore A. Other suitable sealing materials 26 include Teflon® (polytetrafluroethylene or fluorinated ethylene-propylene) and polyether ether ketone. Sealing material 26 also could be nitrile rubber. Further, sealing material 26 may be any other thermoset material, thermoplastic material, or vulcanized material, provided such sealing materials are resilient and capable of withstanding high temperatures, e.g., greater than 400° F.

Energetic material 30 is any material that is capable of quickly generating and, thus, releasing large amounts of energy in a localized area such that any material contacting the energetic material is heated to a temperature sufficiently high to bond the material to a metal surface. Energetic materials include, but are not limited to, thermite materials and reactants for forming intermetallic compounds.

Thermite reactions typically consist of a metal reacting with a metal oxide to produce a metal and metal oxide with the release of a substantial amount of energy and can typically be characterized by the formula:

aX+bYZ→cY+dXZ+ΔE kJ

Examples of such reactions include, but are not limited to:

4Al+3BiO₂→3Bi+2Al₂O₃

2Al+MoO₃→Mo Al₂O3

4Al+3FeO₂→3Fe+2Al₂O₃

Although the foregoing examples show aluminum as the metal for the reaction, persons of ordinary skill in the art will recognize that similar thermite reactions of other materials exist, e.g., tungsten, zirconium, copper, magnesium, and manganese. Likewise, the oxide of the reaction may be any suitable and known oxide.

In a preferred embodiment, the thermite material is made up of thermite particles having a sub-micron particle size distribution and, more preferably, a nanometer size distribution. The sub-micron sized thermite particles have a substantially lower activation energy requirement and react faster, usually more than an order of magnitude faster, than thermite particles having a micron or greater particle size distribution.

Other energetic materials 30 include reactants that form an intermetallic compounds upon the reactants being activated or energized. Intermetallic compound reactions are known in the art. Briefly, intermetallic compound reactions involve two metal reactants reacting together to form a solid state intermetallic compound and which, in the process, release energy. Generally, intermetallic compound reactions can be characterized by the formula:

aX+bY→dXY+ΔE kJ or

aX+bY+cZ→dXYZ+ΔE kJ

One of the most common intermetallic compound reactions is:

Ni+Sn→NiSn

In a preferred embodiment, both reactants for forming the intermetallic compounds, e.g., Ni and Sn in the example above, are disposed together on the same surface. It is to be understood, however, that the reactants may initially be disposed on separate surfaces, e.g., one on the metal surface and the other on sealing material 26, provided that all of the reactants necessary to form the intermetallic compound are placed in contact with each other, or in close proximity to each other, prior to activation of the reactants.

In another preferred embodiment, at least one, and more preferably all, of the reactants for forming the intermetallic compounds, is made up of reactant particles having a sub-micron particle size distribution and, more preferably, a nanometer size distribution. The sub-micron sized reactant particles have a substantially lower activation energy requirement and react faster, usually more than an order of magnitude faster, than reactant particles having a micron or greater particle size distribution.

Both the thermite materials and the reactants for forming the intermetallic compounds are available in powder or sheet form from NovaCentrix of Austin, Tex., Sigma-Aldrich of St. Louis, Mo., and Reactive Nanotechnologies, Inc. of Hunt Valley, Md. In the powdered form, at least one of the components typically has particles that are sub-micron to nano-scale range. In sheet form, the components are typically layered in sub-micron to nano-scale layers.

As illustrated in FIGS. 2-3, in one specific embodiment, sealing material 26 is bonded directly to metal surface 32 of reinforcing ring 22 by placing energetic material 30 between sealing material 26 and metal surface 32 as shown in FIG. 2. Energetic material 30 is initiated or ignited through means known to persons of ordinary skill in the art. For example, an electric charge or radiant heat may be used to energize energetic material 30, causing the energy releasing reaction to begin. The energy released by the energetic material is in the form of heat. Therefore, the temperature along metal surface 32 and bonding surface 34 of the sealing material 26 increases until sealing material 26 bonds to metal surface 32 (FIG. 3). The bonding of the sealing material 26 may be achieved through localized melting (where sealing material 26 is formed of a meltable material such as a thermoplastic material) or thermal degradation (where sealing material 26 is non-meltable material such as a vulcanized, elastomeric, or thermoset material) of sealing material 26 or melting of metal surface 32.

Preferably, energetic material 30 is a high temperature, fast burning or chemically reactive material such that energetic material 30 reacts or combusts in a short amount of time, yet releases a large amount of energy to create a high localized temperature. One advantage of heating sealing material 26 in this manner is that bonding surface 34 is heated quickly such that the heat dissipates before the entire sealing material 26 melts or undergoes thermal degradation. Thus, outer surface 38 of sealing material 26 maintains its integrity and resilience. Persons skilled in the art, without undue experimentation, can easily determine the optimum type and volume of energetic material 30 for use with the desired sealing material 26 or plastic layer 50 (discussed in greater detail below).

In an additional embodiment shown in FIG. 7, layer 29 of metal can be deposited on bonding surface 34 of sealing material 26 to provide a metal to metal bonding through the use of energetic material 30. In this embodiment, a thin layer of metal (not shown) is deposited on bonding surface 34 through sputter or chemical vapor deposition processes known to persons of ordinary skill in the art. The metal being deposited on bonding surface 34 can be a common metal alloy or a material such as solder or brazing compound. Energetic material 30 is then disposed between metal surface 32 and sealing material 26 such that bonding surface 34 with the metal layer deposited thereon is in contact with energetic material 30. Energetic material 30 can then be initiated or ignited, thereby releasing heat and causing metal surface 32 to bond to sealing material 26 through the interface of the metal deposited on bonding surface 34 of sealing material 26.

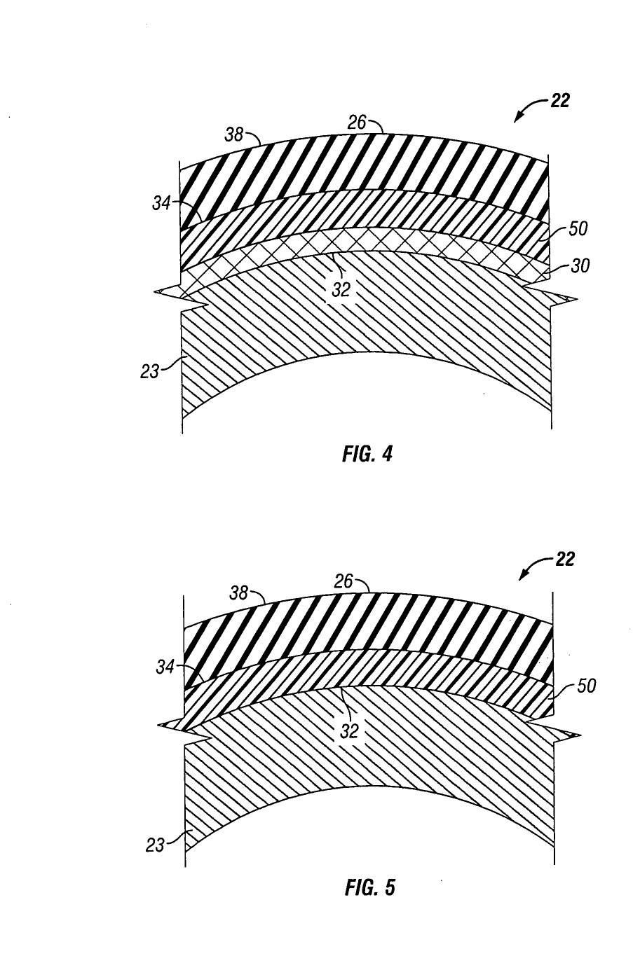

In another embodiment shown in FIGS. 4-5, plastic layer 50 is disposed between sealing material 26 and metal surface 32. Energetic material 30 is disposed between plastic layer 50 and metal surface 32 and, therefore, plastic layer 50 is bonded to metal surface 32 in the same manner as discussed above with respect to the embodiment shown in FIGS. 2-3.

Plastic layer 50 is preferably formed of a melt processable material. The term “melt processable” is used herein to mean a material that is capable of melting and shaping, but becomes thermally stable, i.e., not able to melt, as the downhole application temperature. Thus, the “melt processable” materials after bonding sealing material 26 to metal surface 32, do not re-melt when the tool 10 is disposed downhole. Such “melt processable” materials include thermoset materials as well as thermoplastic materials, provided the melting point, or melting temperature, of the thermoplastic materials is greater than the downhole wellbore temperature where tool 10 is to be operated.

A preferred plastic layer 50 is formed of a perfluroalkoxy material (“PFA”). Polyamidazole may also be used to form plastic layer 50. Plastic layer may also be formed out of fluorinated ethylene propylene (FEP); Chlorotrifluorethylene (CTFE); Ethylenechlorotrifluoroethylene (ECTFE); Ethylenetetrafluoroethylene (ETFE); or Polyvinylidine fluoride (PVF₂). Regardless of the material or type of plastic layer 50 utilized, plastic layer 50 will always be different from sealing material 26.

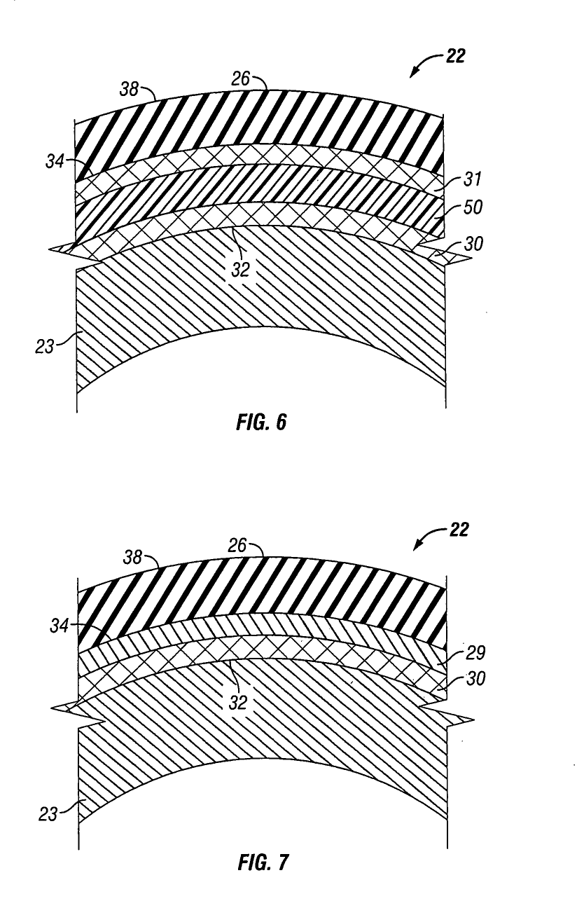

In one specific embodiment, sealing material 26 is bonded to plastic layer 50 by placing a second layer of energetic material 31 (FIG. 6) between sealing material 26 and plastic layer 50. Sealing material 26 is bonded to plastic layer 50 in the same manner as discussed above with respect to plastic layer 50 being bonded to metal surface 32. The resulting seal ring 22 has a cross-section as shown in FIG. 5.

In yet another embodiment, sealing material 26 may be bonded to plastic layer 50 with conventional chemical or adhesive bonding. Because the bonding of sealing material 26 is to the plastic layer 50, known high temperature chemical bonding agents that are capable of withstanding temperatures greater than 400° F. when bonding plastic and elastomers, but are unable to withstand such temperatures when bonding plastic/sealing materials to metal surfaces, can be used.

In bonding sealing material 26 to metal surface 32 in accordance with the embodiment shown in FIGS. 4-5, the order of bonding is not critical. For example, plastic layer 50 may be bonded to sealing material 26 prior to plastic layer 50 being bonded to metal surface 32. Alternatively, plastic layer 50 may be bonded to metal surface 32 prior to plastic layer 50 being bonded to sealing material 26. In still another embodiment, plastic layer 50 is bonded to both sealing material 26 and metal surface 32 simultaneously, such as through simultaneous initiation of energetic material 30 disposed between both plastic layer 50 and metal surface 32 and plastic layer 50 and sealing material 26.

Sealing material 26 bonded to metal surface 32 in accordance with the foregoing embodiments are capable of remaining bonded to metal surface 32 at temperatures in excess of 400° F. and, preferably, at temperatures in excess of 450° F.

It is to be understood that the invention is not limited to the exact details of construction, operation, exact materials, or embodiments shown and described, as modifications and equivalents will be apparent to one skilled in the art. For example, as mentioned, the energetic material may be used to bond a sealing material to any component of a downhole hole having a metal surface to which a sealing material is bonded. Moreover, the component of the downhole tool may be any structural component of the downhole tool, such as the outer wall surface of the downhole tool itself, and is not limited to the seal ring discussed herein. Additionally, chemical bonding agents may be used in combination with the energetic material to bond the sealing material to a plastic layer which is bonded to the metal surface. Further, the sealing material may be any material known to persons of ordinary skill in the art that is capable of providing the necessary function of the sealing material with respect to the specific downhole tool to which it is bonded. Accordingly, the invention is therefore to be limited only by the scope of the appended claims.

1-12. (canceled)

13. A method of bonding a sealing material to a metal surface of a component of a downhole tool, the method comprising the steps of:
(a) disposing an energetic material between a sealing material and a metal surface of a component of a downhole tool; and
(b) energizing the energetic material to create sufficient heat to cause the sealing material to be bonded to the metal surface of the component of the downhole
wherein the metal surface of the component of the downhole tool is first bonded to a plastic layer by disposing the energetic material between the plastic layer and the metal surface of the component of the downhole tool,
the energetic material is then energized to bond the plastic layer to the metal surface of the component of the downhole tool, and
the sealing material is then bonded to the plastic layer.

14. The method of claim 13, wherein the sealing material is first bonded to the plastic layer by disposing the energetic material between the plastic layer and the metal surface of the component of the downhole tool prior to step (b).

15. (canceled)

16. The method of claim 13, wherein the plastic layer is a perfluoroalkoxy material.

17. The method of claim 13, wherein the sealing material is bonded to the plastic layer by disposing additional energetic material between the sealing material and the plastic layer and energizing the energetic material.

18. The method of claim 13, wherein the energetic material comprises a thermite.

19. The method of claim 13, wherein the energetic material comprises at least one reactant for forming an intermetallic compound.

20. The method of claim 13, wherein a bonding metal is disposed on a bonding surface of the sealing material prior to step (b).
